(19) United States
(12) Patent Application Publication
(10) Pub. No.: US 2024/0013803 A1
(43) Pub. Date: Jan. 11, 2024

(54) METHOD ENABLING THE DETECTION OF THE SPEECH SIGNAL ACTIVITY REGIONS

(71) Applicant: CANKAYA UNIVERSITESI, Ankara (TR)

(72) Inventor: Selma OZAYDIN, Ankara (TR)

(73) Assignee: CANKAYA UNIVERSITESI, Ankara (TR)

(21) Appl. No.: 18/017,385

(22) PCT Filed: Nov. 9, 2021
(86) PCT No.: PCT/TR2021/051163

§ 371 Date: Jan. 20, 2023

(30) Foreign Application Priority Data
Dec. 26, 2020 (TR) 2020/21840

(51) Int. Cl. G10L 25/78; G10L 25/09; G10L 25/21

(52) U.S. Cl. CPC G10L 25/78; G10L 25/09; G10L 25/21; G10L 2025/786

(57) ABSTRACT

The invention is about a method enabling the detection of the speech signal activity regions with a new method proposal. The invention relates particularly to a method for encoding signals with a method that allow to determine the voice activity detection (VAD) regions for different input noise signal levels, in which the maximum average energy levels are maintained and least affected from the increasing amount of variance.

### TECHNICAL FIELD OF THE INVENTION

The invention relates to a method enabling the detection of the speech signal activity regions by a new method proposal.

In particular, the invention relates to a method, for input signals in different signal/noise (Signal-to-Noise Ratio—SNR) levels, which is least affected by the increasing variance amount and in which the speech region amplitude levels are best protected even in noisy signals, thereby ensuring that the speech signal activity region (voice activity detection—VAD) detection is obtained with high accuracy.

### STATE OF THE ART

As known, the main aim of the end point detectors is simplicity, resistance to background noises and the detection of acoustic activities reliably. For these reasons, the performance of a VAD detector is measured via the simplicity of the analysis method, the resistance to noise, signal latency, sensitivity, and detection accuracy parameters. For a VAD detector, the borders of the speech signal even in noisy environment is very important.

VAD algorithms perform their processes on the speech signal pieces separated into analysis windows during the pre-processing, and at decision stage for each analysis window, produce a dual result as ‘voiced’ (VAD=1) result in the case of a value above the compared threshold value, and “unvoiced” (VAD=0) otherwise. Pieces with no speech are also referred to as noise in some VAD algorithms. Analysis window length differs in each algorithm and varies within a 5-40 ms range. The accuracy and reliability of VAD algorithms depends on the chosen threshold value as well as the applied method. While the threshold value is constant in some VAD applications, some other VAD applications update the threshold value according to the base noise.

Patent application no “US20170133041A1” in the state of the art is based on 1^{st} and 2^{nd} formant frequencies in the speech signal. This invention is an analysis method conducted on the frequency-domain. In this regard, system calculation complexity is relatively high. This and similar methods have disadvantages due to their process complexities. This method operates by using voice signal coming from two channels.

Patent application no “US20120173234A1” in the state of the art provides the enhancement of VAD accuracy and effectiveness. However, the method used is the method of calculating the GMM (Gaussian Mixture Method) probability parameters from the received speech signal and channel noise signal, calculating and then comparing both of the GMM probability density functions. Calculating the GMM parameters from the speech signal is a highly complex method and conducting the respective analysis in each sound frame for both speech signal and noise signal makes it even more complex.

Patent application no “U.S. Pat. No. 5,867,574A” in the state of the art uses an energy calculation method based on the absolute value of the voice signal derivative. VAD estimation is made by the sum of the amplitude differences of the input signal.

Patent application no “US20010016811A1” in the state of the art proposes placing VAD method in the channel coding algorithm to detect the unvoiced regions in coding the voice signal over the channel. This method is a study towards the detection of the unvoiced regions with the VAD block proposed into the channel coding structure and thereby the effective use of the channel and reducing the number of bits sent over the channel by this way.

Patent application no “KR2014031790A” in the state of the art consists of various blocks having structures of receiving the voice signal, filtering it and signal conditioning, also comprising the VAD algorithm therein. Apart from this, signal filtering and signal conditioning process blocks for resistance to noise signal. It is stated that the VAD analysis is based on autocorrelation method. In this invention, a solution based on energy calculation is proposed. The method that is the subject of this invention is based on the method of analysing the autocorrelation parameters of the filtered signal. Patent application no “WO0221507A2” in the state of the art is an integrated circuit block based on an analysis taking into account zero crossing rate—ZCR and energy values separately. In each analysis window, it first calculates the energy value and then calculates an average ZCR value found from the previous and current analysis windows. However, action is taken according to a predetermined threshold value for ZCR control and VAD analysis is made in accordance with whether the calculated ZCR value in the analysis window is over or below the predetermined threshold value. Said patent study does not propose a solution proposed with this document and in which the ZCR and energy values are formulated together. Analysis of voiced/unvoiced VAD regions according to ZCR calculation based on only one threshold value both provides a limited analysis possibility and is an analysis method the accuracy rate of which rapidly decreases as the input signal noise level increases, and loses its function particularly in noisy signals.

Patent application no “CN108899041A” in the state of the art discloses a signal quantisation method. It also comprises a VAD algorithm. However, the subject of the patent is understood more of a quantisation method rather than the VAD algorithm.

Patent document no “2018/11073” in the state of the art is reviewed. The following information is given in the abstract part of the invention subject to the application: “among a coding method based on periodicity and a method that is not based on periodicity, in a coding method that is expected to produce less amount of code, the code amount of an integer value sequence and an estimated value of the code amount is obtained during the adjustment of the gain. In the other coding method, an integer value sequence obtained in this process is extracted and the code amount or an estimated value of the code amount of the integer value sequence is obtained. Obtained code amounts or estimated values are compared in order to choose one of the coding methods, and integer value sequence is coded using the selected coding method and thereby an integer signal code is obtained and outputted.”

VAD detectors based on energy calculation used in the state of the art need to investigate in the forward/backward analysis windows and need decision improving algorithms to be able to find where the speech signal begins and ends exactly. Said need of analysis in the forward/backward speech windows is not suitable for real-time speech processing detectors.

In the digital speech processing applications used in the state of the art, detection of the speech active regions of the speech signal is a very important matter. Voice activity detection (VAD) detectors are used almost in all fields of digital speech signal processing such as speech recognition, echo cancellation and VoIP (Voice Over Internet Protocol). Separating speech active regions from unvoiced regions within the voice signal is of significant importance as it will minimize analysis periods of speech processing methods. Particularly in speech recognition methods, false determination of speech active regions will cause significant disruptions in resultant signal. High performance VAD detectors increase the band width in VoIP applications and enable more users to use the same band. Studies conducted on VAD detection until today are conducted on time-domain or frequency-domain. Detectors on time-domain are generally based on energy calculation and/or zero crossing rate—ZCR methods and process by evaluating both parameters separately. Frequency-domain methods on the other hand use the spectrum information. Time-domain detectors are simpler compared to detectors analysing on the frequency-domain in terms of calculation and parameters of simplicity and effectiveness in calculation are very important in VAD detectors. By this way, it will be possible for VAD detectors to be applied so as not to cause a significant latency in speech processing methods. In the time-domain analysis, the amplitude of the speech signal on the analysis window is an important parameter in separating speech active and unvoiced regions. If the SNR value of the input signal is high, the smallest voice level above a threshold calculated by taking the background noise into account can be determined with an energy calculation for voiced and unvoiced regions. However, in real-time practical applications, voice recording conditions with very high SNR levels cannot be created. Speech signal is separated into two parts as voiced/unvoiced in speech active regions. In also separating the voiced signals from the unvoiced ones, signal amplitude is an important indicator. Peak amplitude of the voiced speech signals are approximately five times bigger than the peak amplitudes of the unvoiced speech signals, and it is possible for the voiced signals to be separated by energy calculation method, however, due to their low amplitudes, it is difficult to separate the unvoiced signals from the silent regions where no speech takes place. Detectors based on the energy calculation on the time-domain applied until today use either the sum of the squares of the signal amplitudes in the analysis window (Equation-9) or active value energy calculation as square root of the sum of the squares of the amplitudes (Equation-10) in energy calculation. Then, voiced/unvoiced VAD regions are separated according to a determined threshold value. However, when in both methods signal energy is the base noise, separating the noise and signal becomes difficult and during the voiced/unvoiced decision, decision improving by analysing within the forward and back analysis windows is needed. Another time-domain analysis method ZCR in some VAD detectors is based on ZCR value in voiced and unvoiced signals within an analysis window being different from each other. ZCR value of any speech signal is determined according to sign change amount of speech signal samples relative to horizontal axis. Unvoiced speech signal ZCR value is an analysis window is higher compared to the voiced speech signal ZCR value. On the other hand, if there is base noise within the speech signal, since it affects the ZCR value for both the voiced and unvoiced signals, it is not possible to use the ZCR value alone for the detection of the VAD regions.

For the ZCR value control in the state of the art, the detection is tried to determine whether the calculated ZCR value remains within certain ZCR proportional value ranges. On the other hand, in the detection of the VAD regions, determining the ZCT values that can formulate several different conditions within the speech signal is quite difficult and requires considering a great deal of possibilities. This makes it difficult to find speech end points in VAD detectors by using the ZCR value alone. For this reason, in the common use up to day, ZCR and energy values are used together for the detection of VAD regions. On the other hand, in the said applications, the analysis is performed by looking at the ZCR and energy values calculated within the analysis window “separately” and by making a statistical evaluation, for example, according to the ZCR value being below or above certain threshold values and in cases where decision difficulties are encountered, the analysis window is divided into sub-windows and VAD analysis is performed again in these sub-windows. The use of ZCR value in this way for the detection of VAD regions will create a rather uncertain situation since each designer will determine their own ZCR threshold value based on their own observations, and it will be very difficult to determine a threshold, especially for signals with high background noise, since a single threshold cannot be determined to cover all possible speech signal situations. The use of ZCR value in this way for the detection of VAD regions will create a rather uncertain situation since each designer will determine their own ZCR threshold value based on their own observations, and it will be very difficult to determine a threshold, especially for signals with high background noise, since a single threshold cannot be determined to cover all possible speech signal situations. For this reason, VAD algorithms in which energy and ZCR values are used together cannot produce the desired high success although they provide better results compared to the VAD detections made using the energy values alone.

Conclusively, due to the above mentioned problems and the insufficiency of the existing solutions made it necessary to make an improvement in the relevant technical field. Within the scope of this study, a use in which the energy value and ZCR value within the analysis window is used together is formulated.

### THE AIM OF THE INVENTION

The most important aim of the invention is to obtain, for input signal with varying SNR noise levels, a Voice Activity Detection (VAD) that is least affected by the increasing variance amount and in which the maximum average energy levels are preserved.

Another important aim of the invention is to detect the signal activity regions even in high noisy signals with the signal obtained based on a formula calculated above the energy value and zero crossing rate (ZCR) value.

Another object of the invention is to realise real-time VAD analysis by obtaining from signals within in each analysis window. By this way, a maximum energy value control is not needed in order to perform the VAD analysis.

One other aim of the invention is to provide an output signal that follows a change consistent with both high amplitude and low amplitude signals in the time domain.

Thus, it becomes possible to distinguish the voiced and unvoiced regions of the signal in real time, even in signals with high noise by analysing the signal value obtained by using the method.

A further aim of the invention is to comprise a method based on the time-domain analysis in which the energy value and ZCR value within the analysis window is formulated together for the first time in literature. By this way, both the need of simplicity in VAD detectors is met and a method in which the two important parameters, energy and ZCR parameters, of the time-domain speech signal are formulated together is provided. Thus, VAD detection on the signal obtained by using the energy value and ZCR value of the signal together is realised successfully. Even though the calculation and analysis is simple, by formulating two important speech signal parameters together, it is ensured that the detection of VAD regions is effective even in speech signals with very high base noise.

Another aim of the invention is to provide a solution to the problem of locating the real end points of speech active regions in a VAD detector (end-point location problem), which is an important problem of speech signal processing, owing to the success of signal obtained by the method that is the subject of the invention in locating the speech activity end-points.

Another aim of the invention is to not use signal filtering on the input signal for resistance to the noise and still perform the VAD analysis of the output signal with high accuracy even in conditions where the input signal comprises high level of noise.

Another one of the aims of the invention is to perform the VAD analysis in which the performance is preserved by using any of the existing energy calculation methods.

Yet another aim of the invention is for the voice coming from a single channel to be sufficient for the method to work.

The structural and characteristic properties and all advantages of the invention will be more clearly understood with the figures given below and the detailed description written. Therefore, the assessment should also be made by taking this detailed description into account.

### DESCRIPTION OF DRAWINGS

FIG. 1; is the drawing providing the test results of the speech active region detection rate (HR1) made for Voiced/Unvoiced (VAD) regions performed with G.729, E2 and E2ZCC detectors for random noisy voices between 100 dB and −15 dB SNR levels.

FIG. 2; is the drawing providing the test results of the speech active region detection rate (HR1) made for Voiced/Unvoiced (VAD) regions performed based on G.729, RMSE and RMSEZCC methods for random noisy voices between 100 dB and −15 dB SNR levels.

FIG. 3; is the drawing presenting the VAD detector flow chart created within the scope of the method that is the subject of the invention.

FIG. 4; is the drawing presenting the E2 and RMSE VAD detectors flow chart obtained by the application of the energy methods in Equations 9-10 to the VAD detector that is the subject of the invention.

### REFERENCE NUMBERS

110. Pre-processing of an input speech signal in time-domain
120. Division of signal into analysis windows with N elements by means of a signal windowing method
130. Determination of the initial values
140. Processor calculating Fwthreshold, Ethreshold, ThresholdvalueE, ThresholdvalueFw values within the analysis window range chosen initially and in accordance with chosen energy calculation method
141. Starting the cycle for the analysis windows
150. Processor making calculation for energy value (E(m)) within the m^{th} analysis windows of the input speech signal and for ZCR(m) value within the same analysis window
151. Comparing ZCR(m) value with minimum zero crossing rate (ZCRmin) value
152. According to the result of the comparison of ZCR(m) value and ZCRmin value, if the ZCR(m) value is smaller than the ZCRmin value, equating the ZCR(m) value to the ZCRmin value
153. If ZCR(m) value is bigger than the ZCRmin, processor comparing the energy value (E(m)) with the minimum energy threshold value (Ethreshold) without performing any processes on the ZCR(m) value
154. According to the result of the comparison of the energy value (E(m)) with the minimum energy threshold value (Ethreshold), if the E(m)) value is smaller than the Ethreshold value, accepting Fw(m) value as zero
160. According to the results of ZCR(m) value with ZCRmin and energy value (E(m)) with minimum energy threshold value (Ethreshold), calculation and derivation of Fw(m) value
170. Comparing Fw(m) signal with threshold value (ThresholdvalueFw)
171. If Fw(m) signal is bigger than ThresholdvalueFw, accepting that there is active voice in VAD region and marking relevant VAD region as ‘1’
172. If Fw(m) signal is smaller than ThresholdvalueFw, accepting that there is no active voice in VAD region and marking relevant VAD region as ‘0’
173. If E(m) value is bigger than ThresholdvalueE, accepting that there is active voice in that VAD region and marking relevant VAD region as ‘1’
174. If E(m) value is smaller than ThresholdvalueE, accepting that there is no active voice in that VAD region and marking relevant VAD region as ‘0’
175. Comparing E(m) signal with threshold value (ThresholdvalueE)
180. Restarting the cycle for the next analysis window

### DESCRIPTION OF THE INVENTION

This invention relates to a new encoder developed for the purpose of coding the signals and the method thereof. The encoder and the method of the invention has been developed in order to obtain, for input signal with varying SNR noise levels, a Voice Activity Detection (VAD) determination that is least affected by the increasing variance amount and in which the maximum average energy levels are protected.

It is determined that with the method that is the subject of the invention, the accuracy percentage of the detection of VAD regions of input speech signals with high base noise is increased significantly. Said VAD algorithm has a modular and simple structure that can be used in all energy calculation-based VAD algorithms. When the proposed method was used in energy calculation based VAD algorithms, significant improvements were observed in the detection of VAD regions. Therefore, the method of the invention meets all the performance expectations listed above for a VAD detector.

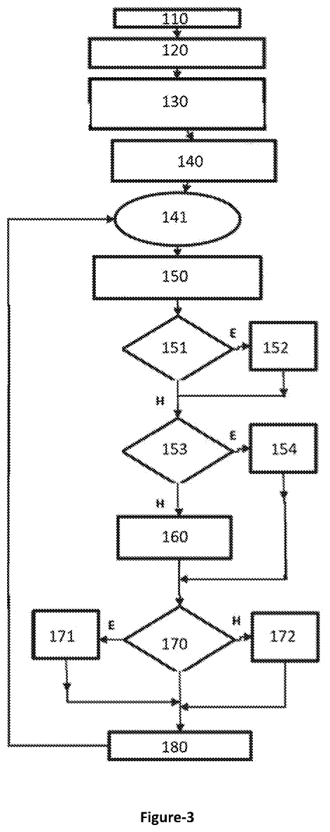

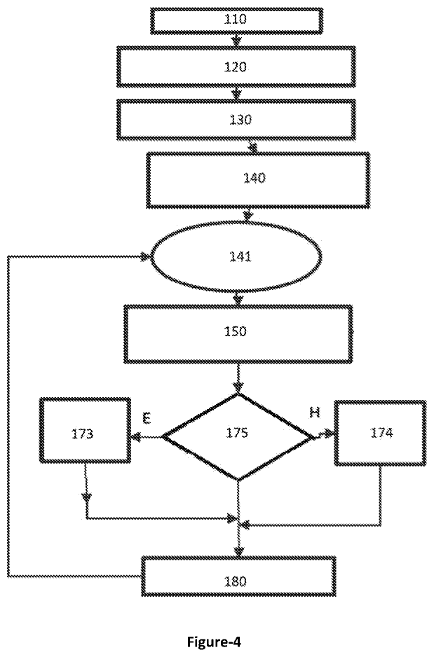

A number of process steps are applied to determine the VAD regions with the method that is the subject of the invention working on a device having a processor and enabling the determination of the speech signal activity regions. These process steps are realised by the processor of any device having a processor. These process steps are as follows: First of all, the device having the processor receives the input speech signal data from the database. Then, an input speech signal on the time-domain (x(n)) is pre-processed by the processor (110). The processor divides the signal into analysis windows with N elements by means of a signal windowing method (120). Initial values are determined in the processor (130). After this determination, the processor calculates Fwthreshold, Ethreshold, ThresholdvalueE, ThresholdvalueFw values within the analysis window range chosen initially and in accordance with chosen energy calculation method (140). For the method in FIG. 3, Equation-2 is used as the threshold value, and for the method in FIG. 4, Equation-7 is used as the threshold value. For the calculation of each window separately, first a processor analysis windows cycle is started (141). All processes are carried out taking the initial value as one (1) and then taking the next value, the cycle continues until all analysis windows belonging to the input signal is completed. After the cycle is started, the processor makes calculation for energy value (E(m)) within the m^{th} analysis windows of the input speech signal and for ZCR(m) value within the same analysis window (150).

After the calculation process, the processor carries out a number of comparisons. For this, the processor first, compares the ZCR(m) value and the minimum zero crossing rate (ZCRmin) value belonging to the relevant analysis window (151). According to the result of the comparison of ZCR(m) value and ZCRmin value, if the ZCR(m) value is smaller than the ZCRmin value, the processor equates the ZCR(m) value to the ZCRmin value (152). If ZCR(m) value is bigger than the ZCRmin, processor compares the energy value (E(m)) with the minimum energy threshold value (Ethreshold) without performing any processes on the ZCR(m) value (153).

According to the result of the comparison of the energy value (E(m)) with the minimum energy threshold value (Ethreshold), if the E(m)) value is smaller than the Ethreshold value, the processor accepts Fw(m) value as zero (154). That is, if the Energy value E(m) calculated for any m^{th} analysis window is smaller than the minimum energy threshold value (Ethreshold), without applying the Equation-1, Fw(m) value is accepted as zero (Fw(m)=0). According to the results of ZCR(m) value with ZCRmin and energy value E(m) with minimum energy threshold value (Ethreshold), processor calculates and derives Fw(m) value (160). After deriving the Fw(m) signal, the processor compares the Fw(m) signal with the threshold value (ThresholdvalueFw) (170).

Threshold value (ThresholdvalueFw) is calculated according to Equation-2. According to the result of the comparison, the processor deems that there is active voice in that VAD region if the Fw(m) signal is bigger than the threshold value. If Fw(m) signal is bigger than ThresholdvalueFw, the processor accepts that there is active voice in VAD region and marks relevant VAD region as ‘1’ (171). According to the result of the comparison, the processor deems that there is no active voice in that VAD region if the Fw(m) signal is smaller than the threshold value. If Fw(m) signal is smaller than ThresholdvalueFw, the processor deems that there is no active voice in VAD region and marks relevant VAD region as ‘0’ (172). By this way, the processor makes the separation of the input signal into VAD regions in real-time using the derived Fw(m) signal. Finally, the processor restarts the cycle for the next analysis window (180). By this way, for the next window to be calculated separately, the processor restarts the cycle for analysis windows again (141).

The difference between the process steps of E2 and RMSE VAD detectors obtained applying the energy methods in Equations-9-10 to the VAD detector that is the subject of the invention given in FIG. 4 is as follows:

After this determination, the processor calculates Fwthreshold, Ethreshold, ThresholdvalueE, ThresholdvalueFw values within the analysis window range chosen initially and in accordance with chosen energy calculation method (140). In the calculation here, Equation-7 is used for the calculation of the threshold value. After the calculation and deriving the Fw(m) signal, the processor compares the E(m) signal with the threshold value (ThresholdvalueE) (175). E(m) value is compared with the ThresholdvalueE calculated according to Equation-7 and then if E(m) value is bigger than the ThresholdvalueE, it is deemed that there is active voice in the VAD region and the relevant VAD region is marked as ‘1’ (173). If E(m) value is smaller than ThresholdvalueE, it is deemed that there is no active voice in that VAD region and relevant VAD region is marked as ‘0’ (174). After separating the input signal into VAD regions in real-time by using the E(m) signal, the cycle is restarted for the next analysis window (180). Then, for the calculation of each window separately, first a processor analysis windows cycle is started (141).

In the calculation of the function by which the VAD regions are present with the method that is the subject of the invention, first an input speech signal in the time-domain (x(n)) is subjected to pre-processing process and divided into analysis windows with N elements by means of windowing method (120). It is assumed that x(n)) speech signal comprises M number of analysis windows in total. In the feature extraction process, after determining by which energy method the calculation will be made, calculation is made for the energy value E(m) within the m^{th} analysis window (m=1, . . . , M) for any input speech signal and for the ZCR(m) value within the same analysis window (150). The energy value of the x(n) signal within the chosen analysis window can be calculated by any energy calculation method such as sum of squares of amplitude (Equation-9) or square root of sum of squares of amplitude (Equation-10).

Within the scope of the method that is the subject of the invention, for the detection of VAD regions, E(m) value calculated in any of the analysis window is divided by ZCR(m) value and a new signal (Fw(m), Equation-1) in time-domain is obtained (160). However, first, whether or not ZCR(m) value is under a value initially determined such as ‘ZCRmin’, if it is, ZCR(m) value is fixed to the ZCRmin value and precaution is taken for the ZCR(m) values that can be found to be close to zero and in such cases, Equation-1 becoming undefined is also prevented. Also, if E(m) value in any analysis window is below the ‘Ethreshold’ value (Equation-6) which is a minimum energy threshold value determined over the energy values within an unvoiced-window range chosen at the beginning, assuming that the VAD analysis will already be zero in these regions, Fw(m) value is determined as ‘zero’ instead of calculating using the Equation-1. The assumptions here are based on the assumption that, in line with the information up to day in the state of the art, there will not be an active speech in the regions having an energy value under an Ethreshold value initially calculated and again on the assumption that there will not be an active speech in the regions having ZCR values below the ZCRmin value. After the said controls, by using the method that is the subject of the invention for the detection of VAD regions, E(m) value calculated in any of the analysis window is divided by ZCR(m) value and a new signal (Fw(m)) in time-domain is obtained. Fw(m) values are calculated by the help of Equation-1. Here, as the E(m) energy calculation method, any energy calculation method in Equation-9 or Equation-10 can be chosen at the beginning of the algorithm as the energy calculation method.

Test results showed that no matter what the chosen energy method is, when the VAD regions on the Fw(m) signal converted by Equation-1 in both energy methods (Equation9→10) is examined, it is seen that the VAD regions belonging to the speech regions is clearly revealed. Since the ZCR(m) value will be high in the regions where the E(m) value is small, the Fw(m) value is small in these regions while Fw(m) value rises significantly in the speech activity regions where the E(m) value is high since ZCR(m) value here is smaller relative to regions where there is no speech. By this way, while the Fw(m) signal found as a result of the function has a small value in unvoiced regions where there is no speech, in the speech activity regions, it rises significantly parallel to the energy value of the speech. Although only energy calculation methods in (Equation 9→10) is tested within the scope of this study, due to the simplicity and effectiveness and adaptability of the method, it is evaluated that any energy calculation method in the state of the art can be used with the proposed method.

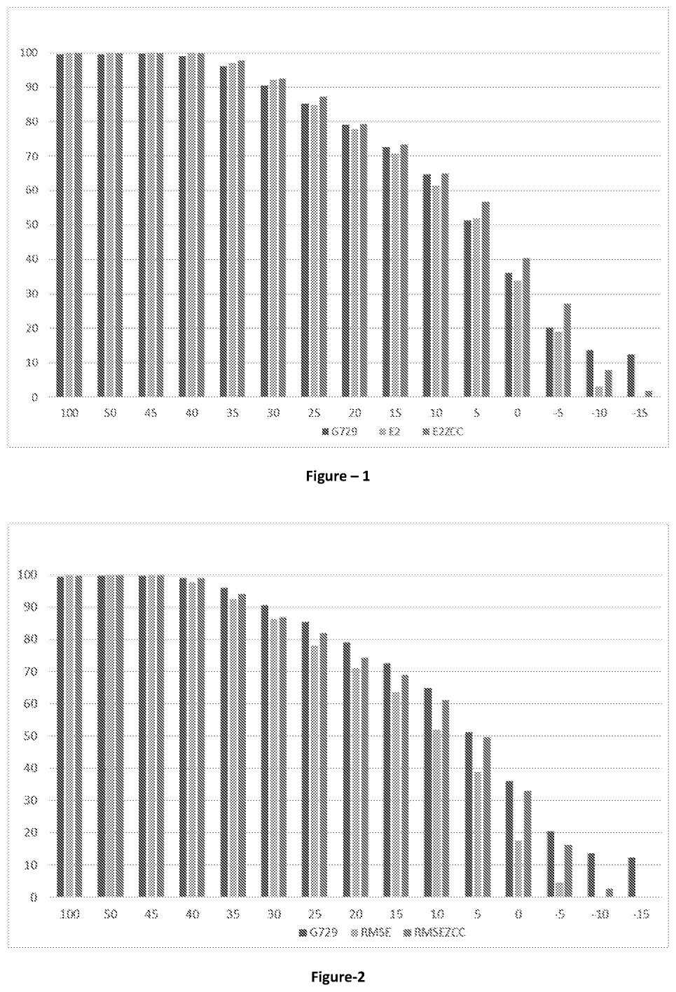

Using the method that is the subject of the invention and the energy calculation methods in Equation-9 and Equation-10 within the method as the energy calculation and complying with the flow chart given in FIG. 3, E2ZCC and RMSEZCC VAD analyses were done and test results were obtained, respectively. By applying energy methods in Equation 9-10 to the VAD detector in FIG. 3, E2ZCC and RMSEZCC VAD detectors were obtained and tested, respectively. In FIG. 4, the E2 and RMSE VAD detectors' flow chart obtained by the application of the energy methods in Equations 9-10 to the VAD detector that is the subject of the invention. Obtained test results are shown in FIG. 1 and FIG. 2. Accordingly, in FIG. 1, graphic on the speech region accurate detection percentage (% HR1) for G729, E2 and E2ZCC are given. In FIG. 2 on the other hand, graphic on the speech region accurate detection percentage (% HR1) for G729, RMSE and RMSEZCC are given.

In the detection of ZCR(m), E(m) and Fw(m) values for the VAD regions detection algorithm of the method, the following conditions are considered: assuming that there is no speech in regions where ZCR(m) value is smaller than a minimum value (ZCRmin) determined at the beginning of the algorithm, in the case that the calculated ZCR(m) value is smaller than the ZCRmin value, ZCRmin value is taken as the ZCR(m) value. In such cases, this value is used in Fw(m) function. (In the tests carried out in this study, ZCRmin=0.01 is chosen). At the beginning of the algorithm, assuming that there is no speech in a certain region (v frames) chosen at the beginning of the speech, an energy minimum value ‘Ethreshold’ is calculated (Equation-6) for a determined period (v frames) as unvoiced of x(n) speech signal and is used for a decision on speech activation activity in the current analysis window. Further, in the said unvoiced region the average value ‘Fwthreshold’ values calculated from the Fw(m) values calculated using Equation was calculated (Equation-3). If the Energy value E(m) calculated for any m^{th} analysis window is smaller than the Ethreshold value, without applying the Equation-1, Fw(m)=0 is accepted. For E(m) and ZCR(m) values in all other analysis windows, Fw(m) values are as in Equation-1. Also, ‘ThresholdvalueFw’ value applied for the detection of VAD regions is found by the help of Equation-2. Here, as the result of multiplying the Fwthreshold value found in a silence region determined at the beginning of the speech signal and a ‘multip’ value chosen at the beginning, an offset value also determined in the beginning can be added and obtained ‘ThresholdvalueFw’ value is used in the decision of voiced/unvoiced VAD regions in all analysis windows. (In the tests applied with the method that is the subject of the invention, multip=1.7, offset=0 are chosen). To prove the effectiveness of the method that is the subject of the invention, a fixed value is used as a threshold, however, a threshold calculation adaptable for the environments where the noise value constantly changes can also be calculated when desired.

VAD detector designed in the method uses the short-term signal energy (Equation-9→10) calculated using any of the energy calculation methods of an x(n) input signal and the Zero Crossing Rate (ZCR) (Equation-4) information of the signal in the analysis window together (in Equation-4, w(n) is the chosen windowing method). With the said new detector designed by using energy and ZCR values together, speech signal active regions are clearly revealed by being separated from the regions where there is no speech and thereby signal activity regions of the input speech signal is clearly presented. To evaluate the performance of the method, short-term energy and ZCR values calculated in the time-domain are used. As also described in the flow-chart in FIG. 3, with the method, as the energy value in Equation-1 in the Method, two different VAD algorithms are designed using the energy method in Equation-9 and the energy method in Equation-10 (E2ZCC and RMSEZCC, respectively).

To evaluate the effectiveness of the method, as described in the flow-chart in FIG. 4, the design of only two different VAD algorithms based on energy calculation in the time-domain was made and these were compared with the method (VAD analysis method created based on Equation-9 (referred to E2 method in this document) and VAD analysis method created based on Equation-10 (referred to as RMSE method in this document)).

To evaluate all analysed VADs under different acoustic conditions, the effectiveness thereof was tested by taking a 30-minute input signal created from the clean speech signals within the TIMIT database as reference and in conditions where random Gaussian noise signal between (100 dB and −15 dB) were added to this signal in gradually varied ratios. TIMIT database used in experimental studies is a database created by LDC (Linguistic Data Consortium), containing phonetically rich sentences therein and is commonly used by the systems based on speech in the state of the art for the testing purposes. TIMIT database used during tests comprises voice signal samples exemplified in 8000 Hz. In all detectors designed in this study, analysis window is determined as 10 ms. This corresponds to N=80 number of samples in an analysis window.

The results show that the method that is the subject of the invention obtain a higher accuracy than the VAD methods based only on the energy even in negative environmental conditions under 0 dB where the background noise level rises significantly.

By means of the found Fw(x(n)) function and the method developed within the frame of this function, a quite successful speech activity region is presented even under high noise conditions. Within this scope, Fw(x(n)) function was used for the purpose of separating the voiced and unvoiced regions in the detection process of VAD regions of a speech signal. In tests made with different energy calculation methods, it was seen that the result of the Fw(x(n)) function calculated for each energy method provides significantly successful results even in signals with high noise. Speech activity regions (VAD) algorithm designed within the scope of the method that is the subject of the invention may use any energy calculation method in the separation of the voiced/unvoiced regions of the speech signal. It was seen as a result of the tests performed that no matter which energy function between Equation 9-10 is used, when these are used together with the method that is the subject of the invention, the accuracy rate of the detection of the speech activity regions rises significantly (FIG. 1, FIG. 2). By this way, the detection of the VAD regions for voices without any noise or with low base noise is realised with very high accuracy rate, and the accuracy rate of the detection of VAD regions in speech voices with high base noise rises.

$$Fw ( m ) = \frac{E ( m )}{ACR ( ) m )} , m = 1 , … . . , M \qquad ( 1 )$$

ThresholdvalueFw=multip*Fw_{threshold}+offset,multip,offset:constant values (2)

$$Fwthreshold = \frac{1}{v} {\sum }_{i = 0}^{v} F w ( i ) , \qquad ( 3 )$$

$$Z C R ( m ) = \frac{1}{2 * N} {\sum }_{n = 1}^{N} \vert sign ( x [ n ] ) - sign ( [ x [ n - 1 ] ) \vert * w ( m - n ) , \qquad ( 4 )$$

$$here ,$$

$$sign ( x [ n ] ) = \{ \begin{matrix}- 1 , x < 0 \\ 0 , x = 0 \\ 1 , x > 0\end{matrix} \qquad ( 5 )$$

Briefly, in the VAD method used in the method that is the subject of the invention, threshold values in Equation-2 and Equation-3 were then used to distinguish between voiced/unvoiced speech windows (VAD).

An energy threshold value is determined from the selected analysis windows and stored to be able to conduct a voiced/unvoiced speech analysis. In the second step, a chosen energy calculation method is applied to the speech signal in each analysis window of the speech signals and energy calculation of the signal is done. The calculated energy value is compared to the initially determined threshold value and separation of voiced/unvoiced regions are done. The effectiveness of the VAD algorithms created using the method schematically presented in FIG. 3 and the energy methods in Equation-9 and Equation-10 as the energy calculation within the method (E2ZCC and RMSEZCC detectors, respectively) relative to the VAD detectors designed using the energy calculations in Equation-9 and Equation-10 as the energy calculations methods in FIG. 4 (E2 and RMSE detectors, respectively) was tried for the noise-free and noisy speech signals with different SNR values, and significantly successful results were obtained. The results showed that the effectiveness of the method that is the subject of the invention in detection of the voiced/unvoiced speech regions is significantly high compared to VAD algorithms based only on the energy methods, particularly in the signals with high noise. Also, the limitations in the real-time application based only on the energy calculation methods in the state of the art in Equation-9 and Equation-10 are eliminated with the method that is the subject of the invention.

In the analyses performed with the method that is the subject of the invention, if the energy value in the analysis window exceeds the determined threshold value, the beginning point of the speech signal is found and marked as K1. The regions above the threshold value are defined as “speech active” regions. When the calculated energy value falls again below the threshold value, the ending point of the speech signal is determined and marked as K2. During all tests, experiments were done by keeping the minimum energy threshold value (Ethreshold) fixed. However, when the value calculation is desired to be made for the speech signals in which the background noise varies, it can be calculated in an adaptive manner. As can be seen from the test results in FIG. 1 and FIG. 2, the energy level detection with the method that is the subject of the invention for the input speech signals with particularly high noise can be realised even when the SNR level is around −15 dB. Test results for the detection of VAD regions in FIG. 1 and FIG. 2 can be summarised as follows:

All energy calculation formulas in Equation-9, Equation-10 for the detection of VAD regions were tested together with the method that is the subject of the invention. To this end, Amplitude-square energy method (Equation-9) and Rms energy method (Equation-10) was considered respectively and applying on the VAD detector in FIG. 3 proposed within the scope of the method that is the subject of the invention, E2ZCC and RMSEZCC VAD analysis were designed, respectively. As seen in FIG. 1 and FIG. 2, for the clean voice signal, the VAD region decisions of all methods are more or less equal. Also, in around 50 dB SNR value, VAD regions of each method is close to one another. On the other hand, as a result of the energy calculations combined with the method that is the subject of the invention, VAD regions continue to be detected in a wide range. When the SNR value is below 0 dB, VAD analyses performed according to Equation-9 and Equation-10 (E2 and RMSE VAD analyses) lose their detection capability. In the VAD analyses combined with the method that is the subject of the invention (E2ZCC and RMSEZCC method), VAD regions preserve their high amplitudes and exhibit a successful performance compared to other methods. Even around SNR −15 dB value, it continues to detect energy regions of the signals the amplitude values of which remain over the noise signal. ZCR calculation is made in accordance with Equation-4 and taking Equation-5 into account.

As it uses a fixed threshold as the threshold value, the method that is the subject of the invention was tested on speech signals with Gaussian random base noise effect It is assessed that the method can be used in effectively revealing the signal speech activity regions in several digital speech processing applications due to its high performance in noisy speech signals.

In the tests performed using all energy methods (Equation (9-10)), the performances of VAD analyses (E2ZCC and RMSEZCC) created within the scope of the method that is the subject of the invention using the Energy and ZCR values and VAD detection results (E2 and RMSE) obtained using only the relevant energy methods together were measured, similar threshold value calculation functions were used in the threshold value calculation of each method and similar multiplier and offset values were chosen.

For instance, for energy based E2 and RMSE detectors, ThresholdvalueE is calculated by using Equation-6 and Equation-7. E2ZCC and RMSE detectors designed using the method that is the subject of the invention, ThresholdvalueFw is calculated by using Equation-2 and Equation-3. With similar threshold calculation methods as such, it could have been possible to compare the performances of the energy based calculation methods and the method that is the subject of the invention with one another. Furthermore, without adding any method ‘for the improvement of the decision’ in the VAD encoders already used in the state of the art in VAD detection, it could have been possible to compare the effects of the VAD analysis based only on energy calculation and the method that is the subject of the invention.

With the method that is the subject of the invention, first the input signal is pre-processed. Energy levels of the input signals are calculated. After pre-processing, feature extraction is done. ThresholdvalueFw calculation is done (Equation-2) and VAD regions are determined after this calculation. In the calculation of the function by which the VAD regions are present with the method that is the subject of the invention, first an input speech signal in the time-domain (x(n)) is subjected to pre-processing process and divided into analysis windows with N elements by means of windowing method. It is assumed that x(n)) speech signal comprises M number of analysis windows in total. In the feature extraction process, after determining by which energy method the calculation will be made first, calculation is made for the energy value E(m) within the m^{th} analysis window (m=1, . . . , M) for any input speech signal and for the ZCR(m) value within the same analysis window. The energy value of the x(n) signal within the chosen analysis window can be calculated by any energy calculation method such as sum of squares of amplitude (Equation-9) or square root of sum of squares of amplitude (Equation-10).

In accordance with the test results made with the method that is the subject of the invention, the effectiveness of the equation used in the method (Equation-1) in the calculation of the speech active regions particularly in noisy signals is significantly clear. When the energy calculation (E(x(n))) is made only with any energy calculation method in (Equation-(9-10)) for the noisy input speech signals (x(n)), the difference between the energy amplitude values of the noisy speech signals and amplitude values of the base noise energy decreases rapidly with noise effect. For this reason, a new formula is developed by using ZCR value and energy amplitude values together within the scope of the method that is the subject of the invention and is used for the identification of the voice activity detection (VAD) regions of the speech signal by re-defining as in Equation-1.

Within this scope, the energy levels within an analysis window of the x(n) input signal are calculated by using any of the energy calculation formulas between Equation9-10, ZCR values were calculated and then the detection of VAD regions remaining over a ThresholdvalueFw found by using Equation-2, quite successful results were obtained in the detection of speech regions and in resistance to noise of VAD regions.

For the ThresholdvalueFw calculation in Equation-2, at the beginning of the speech signal, v number of analysis windows are chosen (depending on the chosen analysis window length, v may be selected as a value between (1-20) or bigger when desired), it is assumed that there is no speech in this v number of analysis windows, and for an Fw(x(n)) average threshold value within the average noise in the unvoiced regions, average value (Fw_{threshold}) of the Fw(x(n)) values obtained by the help of Equation-1 is calculated from (x(n)) signal. Fw_{threshold} value is multiplied by a chosen ‘multip’ value and an offset value is added when desired and is recorded as Fw(x(n)) threshold value (ThresholdvalueFw). Also, within the chosen v number of analysis windows, assuming that x(n) signal does not contain speech, average energy value in this unvoiced region is found and recorded as Ethreshold value.

In the general approach for threshold value calculation in energy-based VAD algorithms, ThresholdvalueE is calculated by assuming that there is no speech in the signal within a certain period (v number of analysis windows) initially as in Equation-6, and by using average energy of the signals within the chosen analysis windows (Ethreshold) and Equation-7. Then, signal energy (E(m)) in any m^{th} analysis window is compared with the ThresholdvalueE and VAD=1 decision is taken for the energy regions remaining above ThresholdvalueE. Besides, there also are algorithms that continuously adapt the threshold value in accordance with the background noise in windows with no speech. It is evaluated that VAD analysis can be done in such type of algorithms as well by using the method in this study and a threshold value adapted to the change in the base noise.

$$Ethreshold = \frac{1}{v} {\sum }_{i = 0}^{v} E ( i ) , \qquad ( 6 )$$

ThresholdvalueE=multip*Ethreshold+offset,multip,offset:constant values (7)

Generally, if i^{th} example of a voice signal with N-number of samples in a j^{th} analysis window is x(i), the analysis window fᵢ can be represented as in Equation-8.

$${f}_{i} = {\{ x ( i ) \}}_{i = ( j - 1 ) \cdot N + 1}^{j \cdot N} \qquad ( 8 )$$

E2 VAD detector uses the formula in Equation-9 as the energy calculation method. The method designed in the energy calculation of an x(n) input speech signal in the time-domain for the energy calculation method from Amplitude-square from x(n) input signal (Equation-9) is as follows: x(n) signal is separated into M number of analysis windows in total with N number of elements using windowing method, (v number of) Ethreshold value within the initially chosen unvoiced region is determined. ThresholdvalueE is calculated by using Equation-6 and Equation-7. For a speech signal in an m^{th} analysis window, energy value (E(m)) is calculated by using Equation-9 and taking the average value of the amplitude squares of the input signal. Then the E(m) value is compared with ThresholdvalueE and VAD=1 decision is taken for the regions above ThresholdvalueE, and VAD=0 decision is taken for those below. (During tests, multip=1.7, offfset=0 are taken).

RMSE VAD detector is as follows. The detector is designed to make energy calculation with the rms energy calculation method from an x(n) input signal in a time-domain (Equation-10). x(n) signal is separated into M number of analysis windows in total with N number of elements using windowing method, (v number of) Ethreshold value within the initially chosen unvoiced region is determined. ThresholdvalueE is calculated by using Equation-6 and Equation-7. For a speech signal in an m^{th} analysis window, energy value (E(m)) is calculated by using Equation-10 and taking the average value of the amplitude squares of the input signal. Then the E(m) value is compared with ThresholdvalueE and VAD=1 decision is taken for the regions above ThresholdvalueE, and VAD=0 decision is taken for those below. (During tests, multip=1.7, offfset=0 are taken).

$$E ( m ) = \frac{1}{N} {\sum }_{n = m \cdot N}^{m \cdot N + N - 1} {x ( n )}^{2} , \qquad ( 9 )$$

$$m = 1 , … … , M$$

$${E}_{rms} = \sqrt{( \frac{1}{N} ) {\sum }_{n = m \cdot N}^{m \cdot N + N - 1} {x ( n )}^{2}} , \qquad ( 10 )$$

$$m = 1 , … … , M$$

The method that is the subject of the invention is an effective method in revealing the signal activity regions with very high amplitude along with its simplicity. This significantly facilitates the separation of the voiced and unvoiced regions and increases the detection accuracy rate. In the method that is the subject of the invention, energy calculation is made by using Equation-9 and Equation-10. These equations are used as they are the most used two equations (Equation-9 and Equation-10) in energy calculation and any energy calculation method can be used in the method that is the subject of the invention.

A speech processing system should provide an effective performance in the separation of the unvoiced speech sounds with very low amplitude compared to voiced speech signals from the regions where there is no speech. In the speech sounds with background noise signal on the other hand, it is very hard to separate unvoiced speech signals from the background noise.

Here, the inventive method ensures that speech signals can be detected and separated from background noise even when the background noise signals are quite high, and it offers a very good performance compared to the separation made according to the normal energy calculation. Also, energy calculation method based on the sum of the amplitude squares of the signals within the analysis window in the state of the art provides an insufficient performance due to the energy values close to the threshold value, particularly in the separation of the unvoiced speech signals from the background noise signals. Additionally, by dividing the total energy by the number of signals in the analysis window, energy value decreases significantly and this in turn makes the VAD detection based on signal energy difficult. For this reason, in the uniform energy calculation only total value of amplitude squares is used, and in this case, to be able to do energy-based analysis, either maximum energy calculation in the speech signal is required or updating the threshold value in the separation of the voiced/unvoiced is needed in each analysis window. All these make the possibility of the real-time analysis based only on energy difficult.

In the method that is the subject of the invention, a change compatible with the input signal and in which the time-domain amplitudes of the input speech signal are clearly presented with the signal (Fw(m)) derived using the signal energy value calculated from input signal within the analysis window using any method between Equation (9-10) together with ZCR value is seen. For this reason, it is possible to separate the VAD regions of the input signal in real-time by only analysing the derived signal.

Several tests were performed for the detection of the speech activity regions by the method that is the subject of the invention. As a result of these tests, to measure the effectiveness of the method that is the subject of the invention, its effectiveness against the said noisy signals was tried. Within this scope, VAD algorithms based on energy calculation in the time-domain developed using a computer were tried and tested.

Tests were first tried on the “clean” speech signals not comprising background noise, then to be able to measure the resistance to the noise, they were tested with noisy speech signals derived in different SNR levels added onto the clean speech signal.

The method that is the subject of the invention was both tried with different energy-based calculation methods and was compared to a standard VAD algorithm (G.279).

The effectiveness of all analysed VADs were tested under the conditions where random Gaussian noise signal between (100 db and −15 db) were added, gradually and in varying rates, to a 30-minute input signal created from the clean speech signals within the TIMIT database.

During the testing of the analysed VADs, input noisy speech signals of different type having Gaussian random background noise added onto clean speech signal are tested. The results of all performed tests are shown in FIG. 1, FIG. 2. These test results are, for the tested input signal x(n), the results of the detection of VAD regions of E2 and RMSE detectors created based only on the energy calculation methods by applying energy methods in Equation 10, the results of the detection of VAD regions of the E2ZCC and RMSEZCC detectors, respectively, formed by applying the energy methods in Equation 9-10 to the Fw(x(n)) signal in the method that is the subject of the invention and the detection of VAD regions for the standard G.729 VAD detector in the state of the art. As can be seen in the results in FIG. 1 and FIG. 2, for both energy-based methods, detection accuracy percentages of VAD regions have increased when used together with the method that is the subject of the invention. The performance of all VAD algorithms has been done by manually detecting the VAD regions of a clean input speech signal and taking these as reference. All VAD analysis algorithms in the experimental studies were analysed and tested by a computer having a processor and a monitoring device.

The performance of the algorithms was analysed on the basis of resistance to background noise and accurate VAD detection sensing percentage. VAD performance was measured with the accuracy rate in sensing the speech in the state of the art (speech region detection rate (HR1)) and accuracy rate in sensing the noise (non-speech region detection rate (HR0)) measurement parameters.

In the tests, reference VAD decisions obtain by this way from the noise-free speech signal was compared to VAD regions obtained against the noisy input signals created by adding Gaussian random noise with SNR values between 100 dB and −15 dB to the clean input signal. Performed test and their results are shown in FIG. 1 and FIG. 2. VAD detection accuracy was measured with HR1 and HR0 detection values.

In the method that is the subject of the invention, in the measurement of all VAD methods' performances, subjective performance measurement parameters described below are used. Reference VAD regions used for comparison were determined by manually marking the VAD regions of clean speech records. In the VAD methods, how the detection accuracy performance is affected according to the SNR change in the noisy speech signal was measured as the accurate detection rate of the non-speech regions (HR0) (Equation-11) and accurate detection rate of speech regions (HR1) (Equation-11).

$$\% HR 0 = \frac{{N}_{0}}{{N}_{0}^{ref}} \cdot 100 , \qquad ( 11 )$$

$$\% HR 1 = \frac{{N}_{1}}{{N}_{1}^{ref}} \cdot 100 ,$$

N₀^{ref} and N₁^{ref}, comprise total speech (VAD=1) and non-speech (VAD=0) regions of the reference clean speech signal. N0 and N1 are the numbers of non-speech and speech regions detected in the evaluated VAD analysis detector. FIG. 1 and FIG. 2 present the HR0 and HR1 analysis results of the analysed detectors. In the analyses performed, the changes in the HR0 and HR1 detection percentages of detectors according to the varying noise SNR levels in the input signal were focused.

HR1 and HR0 detection values of speech/unvoiced region VAD decisions accurately detected for each speech type were analysed. Almost all VAD methods work with a good performance in the noise-free speech conditions and provide accurate detection rates (for HR1 and HR0) close to 100%. However, as SNR decreases, VAD features differentiate significantly. For each VAD method, the detection rate of the regions comprising speech (HR1) decreases rapidly in low SNR conditions. As for the HR0 rates showing the accurate detection rate of silence region, none of the detectors presented a significant change and therefore they were not needed to be presented as figures. The fact that the method contributed to the increase of the accuracy percentage of the HR1 detection rate were clearly presented with the tests performed (FIG. 1 and FIG. 2), however, as all detectors had nearly the same performance in HR0 rate, the contribution of the method to the HR0 rate could not have been presented in the tests performed.

It is seen from the tests results here that, VAD analysis based on the method that is the subject of the invention (E2ZCC and RMSEZCC) present quite successful results, in all noise levels, compared to VAD analysis realised based only on energy calculation (E2 and RMSE), and additionally, even if SNR noise level of the input signal increases to −15 dB amount, detection of VAD regions can be made and as the noise level increases, HR1 VAD detection rate rapidly increases proportionally compared to methods based only on the energy. When conventional energy calculation methods in Equation-9 and Equation-10 are used alone for VAD detection, as the signal/noise ratio (SNR) of the input signal decreases (in other words, as the noise signal level added on the speech signal increases), separating the original signal from the noise based on the energy values calculation becomes significantly difficult. On the other hand, when the said energy calculation methods are combined with the method that is the subject of the invention, for each of them, with the increasing VAD detection accurate percentage values, they present a quite good performance. The results show that the method that is the subject of the invention obtain a higher accuracy than the energy-based voice activity detection methods even in negative conditions under 0 dB where the background noise level exceeds even the signal level.

To compare the tested method with a standard VAD algorithm, G.729 VAD detector was used and to this end, G.729 ready function in the state of the art was used. G.729-B is a VAD encoder accepted as the standard for fixed telephone and multiple media communications by ITU-T, and analysis window was determined as 10 ms. This corresponds to 80 samples for a voice signal sampled in 8000 Hz. VAD decision is taken by looking at four main parameters as differential power calculation in 0-1 kHz band range in G.729 VAD algorithm, entire band differential power calculation, line spectrum factors (LSF) and zero crossing rate (ZCR). However, as the used ZCR and energy calculation method demonstrates bad performance for the input signals having low SNR, the performance of G-729-B is low for noisy signals.

1. A method to work on a device having a processor, enabling the detection of the speech signal activity regions, comprising the process steps of,
Receiving the input speech signal data from the database to the device with the processor,
An input speech signal on the time-domain (x(n)) being pre-processed by the processor (110),
The processor dividing the signal into analysis windows with N elements by means of a signal windowing method (120),
Initial values being determined in the processor (130),
The processor calculating Fwthreshold, Ethreshold, ThresholdvalueE, ThresholdvalueFw values within the analysis window range chosen initially and in accordance with chosen energy calculation method (140),
The processor starting the cycle for the analysis windows (141),
The processor making calculation for energy value (E(m)) within the m^{th} analysis windows of the input speech signal and for ZCR(m) value within the same analysis window (150),
The processor comparing ZCR(m) value with minimum zero crossing rate (ZCRmin) value (151),
The processor, equating the ZCR(m) value to the ZCRmin value according to the result of the comparison of ZCR(m) value and ZCRmin value, if the ZCR(m) value is smaller than the ZCRmin value (152),
The processor comparing the energy value (E(m)) with the minimum energy threshold value (Ethreshold) without performing any processes on the ZCR(m) value if ZCR(m) value is bigger than the ZCRmin (153),
The processor accepting Fw(m) value as zero if the E(m)) value is smaller than the Ethreshold value according to the result of the comparison of the energy value (E(m)) with the minimum energy threshold value (Ethreshold) (154),
The processor calculating and deriving Fw(m) signal according to the results of ZCR(m) value with ZCRmin and energy value E(m) with minimum energy threshold value (Ethreshold) (160),
The processor comparing Fw(m) signal with threshold value (ThresholdvalueFw) (170),
The processor deeming that there is active voice in VAD region and marking relevant VAD region as ‘1’ if Fw(m) signal is bigger than ThresholdvalueFw, (171),
The processor deeming that there is no active voice in VAD region and marking relevant VAD region as ‘0’ if Fw(m) signal is smaller than ThresholdvalueFw (172),
The processor restarting the cycle for the next analysis window

2. Method enabling the detection of the speech signal activity regions according to claim 1, in the process step where the processor makes calculation for energy value (E(m)) within the m^{th} analysis windows of the input speech signal and for ZCR(m) value within the same analysis window (150);
$$Fw ( m ) = \frac{E ( m )}{Z C R ( m )} , \qquad ( 1 )$$
$$m = 1 , … … , M$$
the processor deriving the Fw(m) signal using the equation.

3. Method enabling the detection of the speech signal activity regions according to claim 1, in the process step where Initial values being determined in the processor (130), the method comprising the process steps of
from the chosen analysis windows, determining an energy threshold value using the
$$ThresholdvalueFw = multip * Fwthreshold + offset , \qquad ( 2 )$$
$$multip , offset : constant values$$
$$Fwthreshold = \frac{1}{v} {\sum }_{i = 0}^{v} Fw ( i ) , \qquad ( 3 )$$
equations,
saving these to be able to perform voiced/unvoiced speech analysis.

4. Method enabling the detection of the speech signal activity regions according to claim 1, in the process step where the processor calculates the energy levels of the input signal in accordance with the chosen calculation method (140),
$$E ( m ) = ( \frac{1}{N} ) {\sum }_{n = m \cdot N}^{m \cdot N + N - 1} x ( n ) \hat{} 2 , \qquad ( 9 )$$
$$m = 1 , … , M$$
$$E rms ( m ) = \sqrt{( \frac{1}{N} ) {\sum }_{n = m \cdot N}^{m \cdot N + N - 1} x ( n ) \hat{} 2} , \qquad ( 10 )$$
$$m = 1 , … , M$$
energy level being able to be calculated by using any of the energy equations.

5. Method enabling the detection of the speech signal activity regions according to claim 1, wherein the method comprises the step of processor calculating the average value ‘Fwthreshold’ values from the calculated Fw(m) values using
$$Fwthreshold = \frac{1}{v} {\sum }_{i = 0}^{v} Fw ( i ) , \qquad ( 3 )$$
equation.

6. Method enabling the detection of the speech signal activity regions according to claim 2, in the process step where Initial values being determined in the processor (130), the method comprising the process steps of
from the chosen analysis windows, determining an energy threshold value using the
$$ThresholdvalueFw = multip * Fwthreshold + offset , \qquad ( 2 )$$
$$multip , offset : constant values$$
$$Fwthreshold = \frac{1}{v} {\sum }_{i = 0}^{v} Fw ( i ) , \qquad ( 3 )$$
equations,
saving these to be able to perform voiced/unvoiced speech analysis.

7. Method enabling the detection of the speech signal activity regions according to claim 2, in the process step where the processor calculates the energy levels of the input signal in accordance with the chosen calculation method (140),
$$E ( m ) = ( \frac{1}{N} ) {\sum }_{n = m \cdot N}^{m \cdot N + N - 1} x ( n ) \hat{} 2 , \qquad ( 9 )$$
$$m = 1 , … , M$$
$$E rms ( m ) = \sqrt{( \frac{1}{N} ) {\sum }_{n = m \cdot N}^{m \cdot N + N - 1} x ( n ) \hat{} 2} , \qquad ( 10 )$$
$$m = 1 , … , M$$
energy level being able to be calculated by using any of the energy equations.

8. Method enabling the detection of the speech signal activity regions according to claim 4, in the process step where the processor calculates the energy levels of the input signal in accordance with the chosen calculation method (140),
$$E ( m ) = ( \frac{1}{N} ) {\sum }_{n = m \cdot N}^{m \cdot N + N - 1} x ( n ) \hat{} 2 , \qquad ( 9 )$$
$$m = 1 , … , M$$
$$E rms ( m ) = \sqrt{( \frac{1}{N} ) {\sum }_{n = m \cdot N}^{m \cdot N + N - 1} x ( n ) \hat{} 2} , \qquad ( 10 )$$
$$m = 1 , … , M$$
energy level being able to be calculated by using any of the energy equations.

9. Method enabling the detection of the speech signal activity regions according to claim 2, wherein the method comprises the step of processor calculating the average value ‘Fwthreshold’ values from the calculated Fw(m) values using
$$Fwthreshold = \frac{1}{v} {\sum }_{i = 0}^{v} Fw ( i ) , \qquad ( 3 )$$
equation.

10. Method enabling the detection of the speech signal activity regions according to claim 3, wherein the method comprises the step of processor calculating the average value ‘Fwthreshold’ values from the calculated Fw(m) values using
$$Fwthreshold = \frac{1}{v} {\sum }_{i = 0}^{v} Fw ( i ) , \qquad ( 3 )$$
equation.

11. Method enabling the detection of the speech signal activity regions according to claim 4, wherein the method comprises the step of processor calculating the average value ‘Fwthreshold’ values from the calculated Fw(m) values using
$$Fwthreshold = \frac{1}{v} {\sum }_{i = 0}^{v} Fw ( i ) , \qquad ( 3 )$$
equation.
